(19) United States
(12) Patent Application Publication
(10) Pub. No.: US 2007/0005646 A1
(43) Pub. Date: Jan. 4, 2007

(54) Analysis of topic dynamics of web search

(75) Inventors: Susan T. Dumais, Kirkland, WA (US); Eric J. Horvitz, Kirkland, WA (US); Xuehua Shen, Urbana, IL (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/171,123

(22) Filed: Jun. 30, 2005

(51) Int. Cl. G06F 17/00

(52) U.S. Cl. 707/104.1

(57) ABSTRACT

The subject invention relates to probabilistic models that are trained from transitions among various topics of pages visited by a sample population of search users. In one aspect, probabilistic models of topic transitions are learned for individual users and groups of users. Topic transitions for individuals versus larger groups are analyzed, wherein the relative accuracies of personal models of topic dynamics with models constructed from sets of pages drawn from similar groups and from a larger population of users are compared. To exploit temporal dynamics, the accuracy of these models are tested for predicting transitions in topics of visits at increasingly more distant times in the future. The models can be applied to search topic dynamics of tagged pages, and then utilized to predict topics of subsequent pages visited by users.

### BACKGROUND OF THE INVENTION

The Web provides opportunities for gathering and analyzing large data sets that reflect users' interactions with web-based services. Analysis and synthesis of the rich data provided by these logs promises to lead to insights about user goals, the development of techniques that provide higher-quality search results based on enhanced content selection and ranking algorithms, and new forms of search personalization. The ability to model and predict users search and browsing behaviors has been explored by developers in several areas. The analysis of URL access patterns has been used to improve Web cache performance and to guide pre-fetching. In general, models developed for caching and pre-fetching average over large numbers of users, and exploit the consistency in access patterns for individual URLs or sites, but do not consider topical consistency. Another line of investigation has explored the paths that users take in browsing and searching web sites. This includes clustering techniques to group users with similar access patterns, with the goal of identifying common user needs. This technology involves detailed analysis of individual web sites. There has been some recent work exploring how page importance computations can be specialized to different users and topics.

There is ongoing technology development on constructing user profiles based on explicit profile specification or on the automatic analysis of the content and link structure of Web pages visited. In general, this technology develops models for individual searchers and does not explore group models or the evolution of interests over time. Several developers have examined user goals in Web search by analyzing Web query logs and have characterized different information needs that users have in searching. They describe potential searchers as motivated by navigational (getting to a web page), informational (learn something about a topic), transactional (acquire something) or resource (obtain something or interact with someone) goals. Topic or content is largely orthogonal to information needs. For example, searchers want to buy things or find out information about a variety of different topics (arts, computers, health, sports, and so forth). Some technologies have analyzed large query logs and summarized general characteristics of Web searches, including the length, syntactic characteristics and frequencies of queries, the number or results pages viewed, and the nature of search sessions. To date however, topics or sites that likely may be visited in the future by respective users have not been modeled or predicted.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The subject invention relates to systems and methods that analyze topic dynamics from queries and web page visits to construct models that predict likely future topics or subsequent pages visited by users. The models are trained from search logs to examine characteristics of topics and transitions among topics associated with queries and page visits by users engaged in searching on the Web or other database. Thus, probabilistic models can be constructed to characterize the distribution of topics for individuals and groups of users, wherein predictions can then be generated to determine future topic search patterns for the respective groups or individuals. The predictive models can be constructed in one example using a training corpus of tagged pages, and then applying these models to predict the topics of subsequent pages or access topics by users. To refine the models in an alternative aspect, differences are determined and compared between the predictive power of individual user models and the models built by analyzing groups of users via comparative and automated data analysis.

In one specific example of the subject invention, Markov and marginal models can be constructed with data drawn from (1) single individuals, (2) composite data from people who have the same topic dominance in the pages they visit during their search sessions, and (3) data from an entire population of users. For these different classes of models, temporal analysis is performed that considers the predictive accuracy of the learned models. Specialized models may be constructed for different periods of time between page visits. In addition, several search applications are supported from the models trained from topic dynamics.

To the accomplishment of the foregoing and related ends, certain illustrative aspects of the invention are described herein in connection with the following description and the annexed drawings. These aspects are indicative of various ways in which the invention may be practiced, all of which are intended to be covered by the subject invention. Other advantages and novel features of the invention may become apparent from the following detailed description of the invention when considered in conjunction with the drawings.

### BRIEF DESCRIPTION OF THE DRAWINGS

FIG. 1 is a schematic block diagram illustrating a search modeling system in accordance with an aspect of the subject invention.

FIG. 2 illustrates exemplary models in accordance with an aspect of the subject invention.

FIG. 3 illustrates an example user groups for model training in accordance with an aspect of the subject invention.

FIG. 4 illustrates an example model training set in accordance with an aspect of the subject invention.

FIG. 5 illustrates an example training log in accordance with an aspect of the subject invention.

FIG. 6 is a flow chart illustrating an example model training process in accordance with an aspect of the subject invention.

FIG. 7 is a diagram illustrating model characteristics in accordance with an aspect of the subject invention.

FIG. 8 is a schematic block diagram illustrating a suitable operating environment in accordance with an aspect of the subject invention.

FIG. 9 is a schematic block diagram of a sample-computing environment with which the subject invention can interact.

### DETAILED DESCRIPTION OF THE INVENTION

The subject invention relates to systems and methods that employ probabilistic models that are trained from transitions among various topics of queries or pages visited by a sample population of search users. In one aspect, a topic analysis system is provided. The system includes one or more learning models that are trained from information access data from a plurality of web sites, wherein such data can be captured in a data store such as a web log. A search component employs the learning models to predict potential future web sites or topics of interest. Probabilistic models of topic transitions are learned for individual users and groups of users. Topic transitions for individuals versus larger groups, the relative accuracies of personal models of topic dynamics with models constructed from sets of pages drawn from similar groups and from a larger population of users are compared and analyzed. To exploit temporal dynamics, the models are developed and tested for predicting transitions in the topics of visits at different times in the future. The models can be applied to search topic dynamics of tagged pages, and then utilized to predict topics of subsequent pages to be visited by users.

As used in this application, the terms “component,” “system,” “object,” “model,” “query,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

As used herein, the term “inference” or “learning” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Furthermore, inference can be based upon logical models or rules, whereby relationships between components or data are determined by an analysis of the data and drawing conclusions therefrom. For instance, by observing that one user interacts with a subset of other users over a network, it may be determined or inferred that this subset of users belongs to a desired social network of interest for the one user as opposed to a plurality of other users who are never or rarely interacted with.

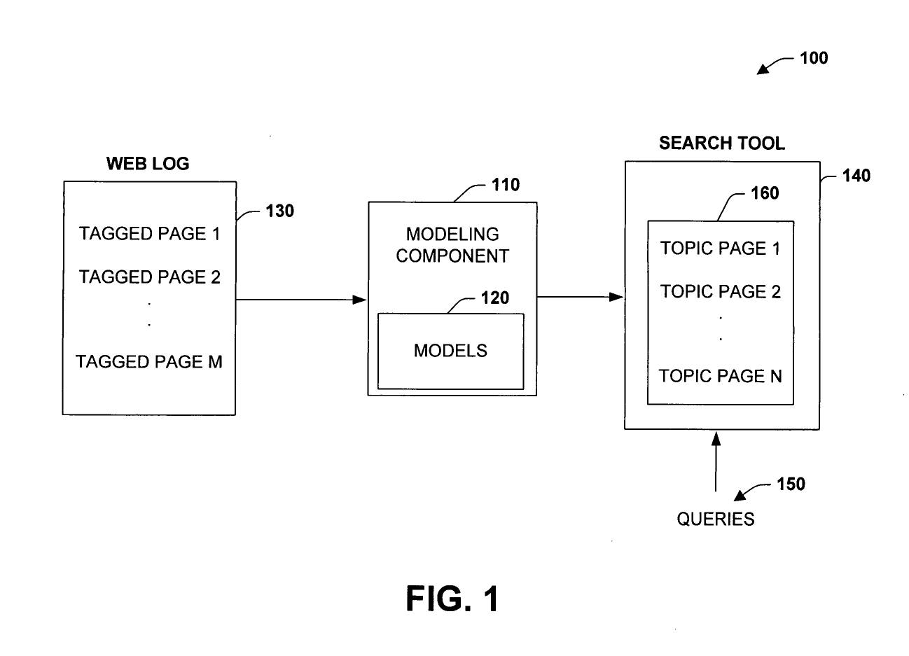

Referring initially to FIG. 1, a search modeling system 100 is illustrated in accordance with an aspect of the subject invention. The system 100 includes a modeling component 110 for generating one or more learning models 120 that can be employed in automated information searches. The modeling component 110 can be operated in a desktop environment or workstation to generate the models 120. In general, the models 120 can be substantially any type of learning model such a Bayesian network model, a marginal model, a Hidden-Markov model, and so forth. Respective models 120 are generally trained from a web log 130, wherein the log may include previous search or web browsing activities of users or groups.

As illustrated, the web log 130 (or search data log) includes a plurality of tagged pages from previous user search activities that have been recorded over time. From such data in the log 130, the models can be trained and then subsequently adapted to a search tool 140 that can be queried at 150 by one or more users to find desired information. In one aspect of the subject inventions, the models 120 and search tool 140 collaborate to form an automated search engine with predictive capabilities to find or mine potential topics of interest. These topics are illustrated at 160 and represented as one or more topic pages which are generated in view of the models 120 and queries 150. Such predicted data 160 can be applied by a plurality of applications such as preferentially retrieving or ranking web pages or web sites based on the models, arranging web sites for optimal viewing, arranging advertising, or generally arranging information or topics to facilitate an optimal experience for users when visiting a respective web site.

One goal of the system 100 is to analyze a plurality of users search behaviors by analyzing log data from a large number of users over an extended period of time. As described in more detail below, this can be achieved by starting with a large log of queries and/or URLs visited over a period of time (e.g., 5 weeks). Typically, each query or URL has a topical category (e.g., Arts, Business, Computers, and so forth) associated with it. Thus, one desires to understand the nature of topics that users explore, the consistency of the topics a user visits over time, and the similarity of users to each other, to groups of users, and to the population as a whole. Beyond elucidation of topic dynamics from large-scale log analysis, the models 120 allow a better understanding of the dynamics of topic viewing over time and to interpret queries and identify informational goals, and, ultimately, to help personalize search and information access.

In other aspects, probabilistic models 120 of the queries issued by or pages visited by individuals, groups of individual and the population of users as a whole can be constructed. Thus, basic statistics about the number of topics that individuals explore, and topic dynamics as a function of time can be determined. In one case, the models 120 allow predictions of the topic of each query or URL that an individual visits over time. Systems use different techniques to predict the topics of URLs based on marginal topic distributions, Markov transition probabilities, or other probabilistic models. Also, the systems can use models derived from analyzing the patterns observed in individuals, groups of similar individuals, and the populations as a whole.

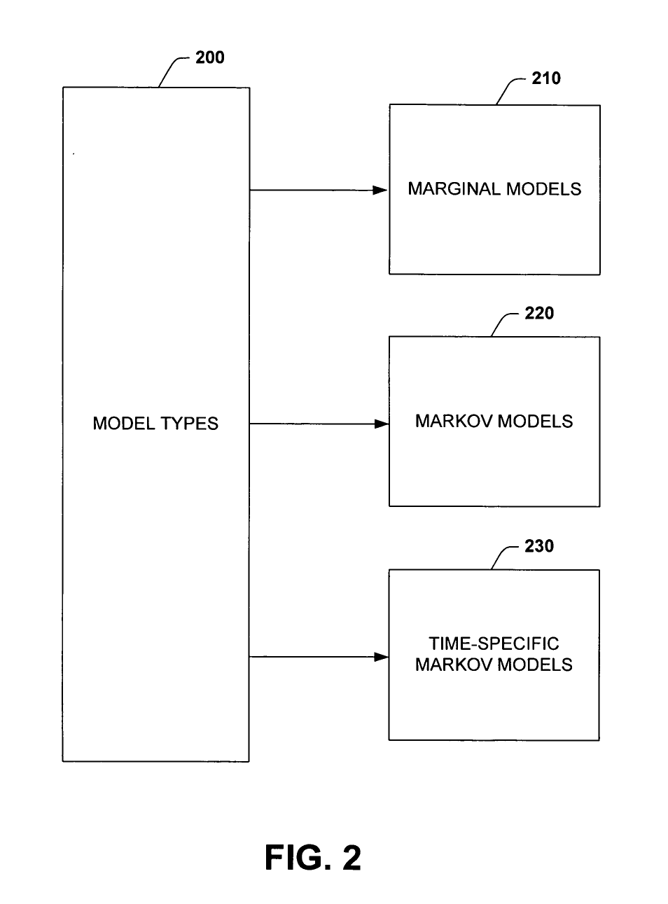

FIG. 2 illustrates exemplary model types 200 in accordance with an aspect of the subject invention. Marginal models 210 use an overall probability distribution for each of a plurality of topics (e.g., 15 topics). The marginal models can serve as a baseline for richer Markov models. At 220, Markov models explicitly represent the probabilities of transitioning among topics. That is, the probability of moving from one topic to another on successive URL visits. The model 220 has many states (e.g., 225 states), each representing transitions from topic to topic (including transitions to the same topic). At 230, time-specific Markov Models are considered. The time-specific Markov models are a refinement of the general Markov model. Again, the probability of moving from one topic to another can be estimated, but different models depending on temporal parameters can be used. In one case, the time gap between when the model is built and when it is evaluated can be varied. In another case, separate transition matrices can be constructed for small time intervals (e.g., less than 5 minutes) and long time intervals (5 or more minutes) between successive actions to differentiate different topic patterns based on time interval. Maximum likelihood techniques can be employed to estimate all model parameters if desired, and Jelinek-Mercer smoothing, for example, to estimate probability distributions.

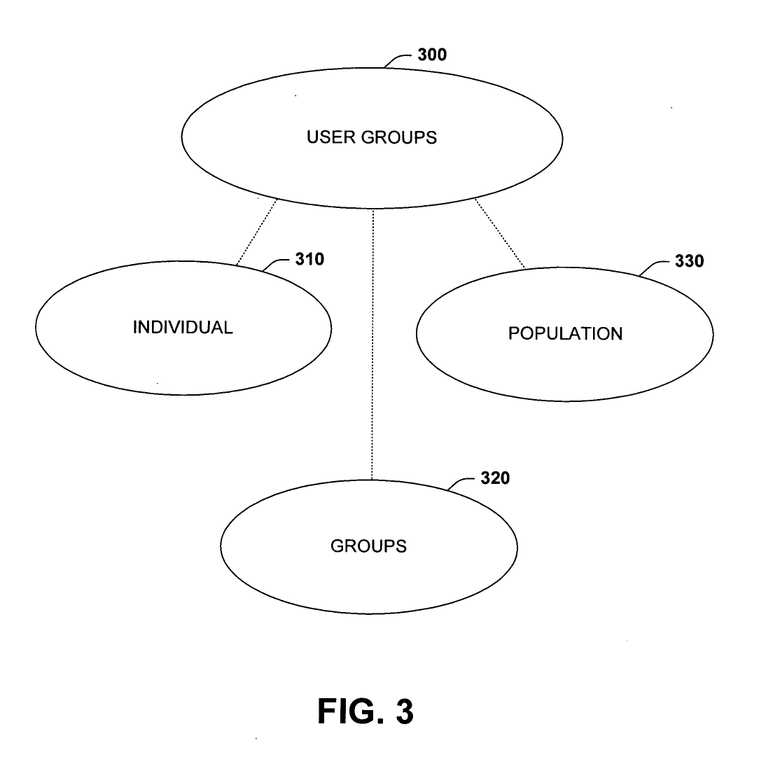

FIG. 3 illustrates example user groups 300 for model training in accordance with an aspect of the subject invention. In this aspect, models are for individuals and for groups, developing marginal and Markov models for individuals 310, similar groups 320, and the population as a whole at 330. These models can be employed to predict the behavior of individual users. At 310, individual users are considered. This technique uses the previous behavior of each individual to predict their current behavior. It was suspected a priori that this would be the most accurate method, but it requires a large amount of storage and, as discovered, appears to have data scarcity problems for more complex models. At 320, group data was considered for the models. This technique uses data from groups of similar individuals to predict the current behavior of an individual. There are many techniques for defining groups of similar individuals. For the data described herein, all individuals were grouped together that had the same maximally visited topic based on their marginal model. At 330, population data was considered. This technique uses data from the entire population to predict the current behavior of an individual.

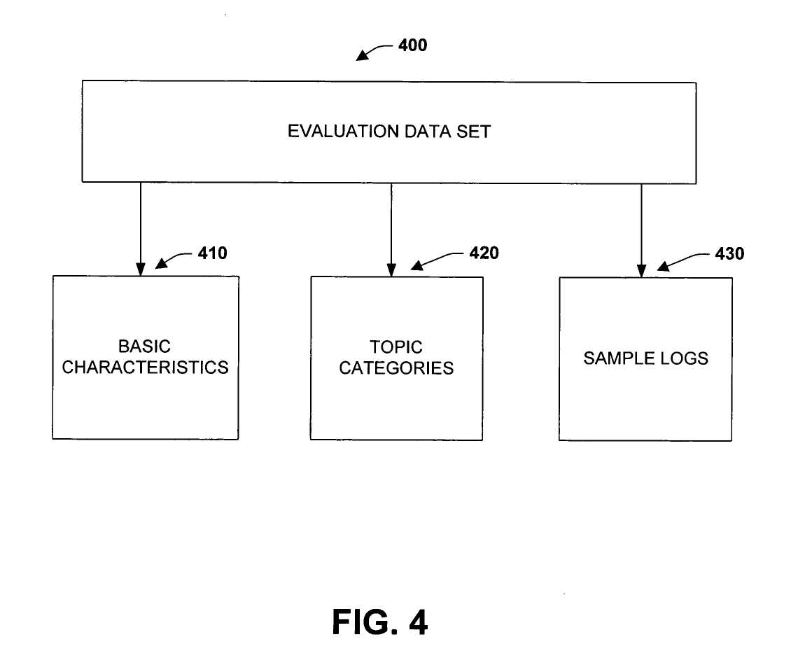

FIG. 4 illustrates an example model training set 400 in accordance with an aspect of the subject invention. At 410, basic data consists of a sample of instrumented traffic collected from a Search engine over a five week period (or other time frame). The instrumentation captured user queries, the list of search results that were returned, and/or the URLs visited from the search results page, for example. The basic user actions worked with include: Client ID, TimeStamp, Action (Query, Clicked), and Value (a string for Query, a URL for Clicked). The data in one sample includes more than 87 million actions from 2.7 million unique users. Queries accounted for 58% of the actions and URL visits for 42% of the actions. Client ID was identified using cookies, and no personally identifiable information was collected. There may be some noise inherent in identifying individuals using cookies (as opposed to requiring a login). However, this represents a relevant analysis scenario for search engine providers, and is the one modeled. Since query and topic dynamics were modeled over time over time, a sample of 6,153 users were selected who had more than 100 actions (either queries or URL visits) over the first two weeks. As can be appreciated, other time frames and sample amounts could be selected. This data set contains more than 660,000 URL visits for which topics could be assigned over time (e.g., five week period).

At 420, there are a number of ways to tag the content of URLs. One method is to use topics from a web directory (e.g., open directory project (ODP)). The ODP is human-edited directory of the Web, which is constructed and maintained by a large group of volunteer editors. At the time of analysis, the directory contained more than 4 million Web pages which are organized into more than 500,000 categories. For one experiment, only the first-level categories from the ODP were used. One method works at any level of analysis. The example topics or categories used were: Adult, Arts, Business, Computers, Games, Health, Home, Kids and Teens, News, Recreation, Reference, Science, Shopping, Society and Sports, for example. Category tags were automatically assigned to each URL using a combination of direct lookup in the ODP (for URLs that were in the directory) and heuristics about the distribution of categories for the site and sub-site of a URL (for URLs that were not in the directory). As can be appreciated, alternative techniques of assignment of category tags, including content analysis via text classification could also be employed.

The above analytical technique is fast to apply and provided about 50% coverage for the URLs clicked on. As described in more detail below, techniques for improving the coverage of automatic topic assignment for URLs are provided and for incorporating a query into topic assignment. One or more topics could be assigned to each URL. On average, it was found that there were 1.30 second-level and 1.11 first-level topics assigned to each URL.

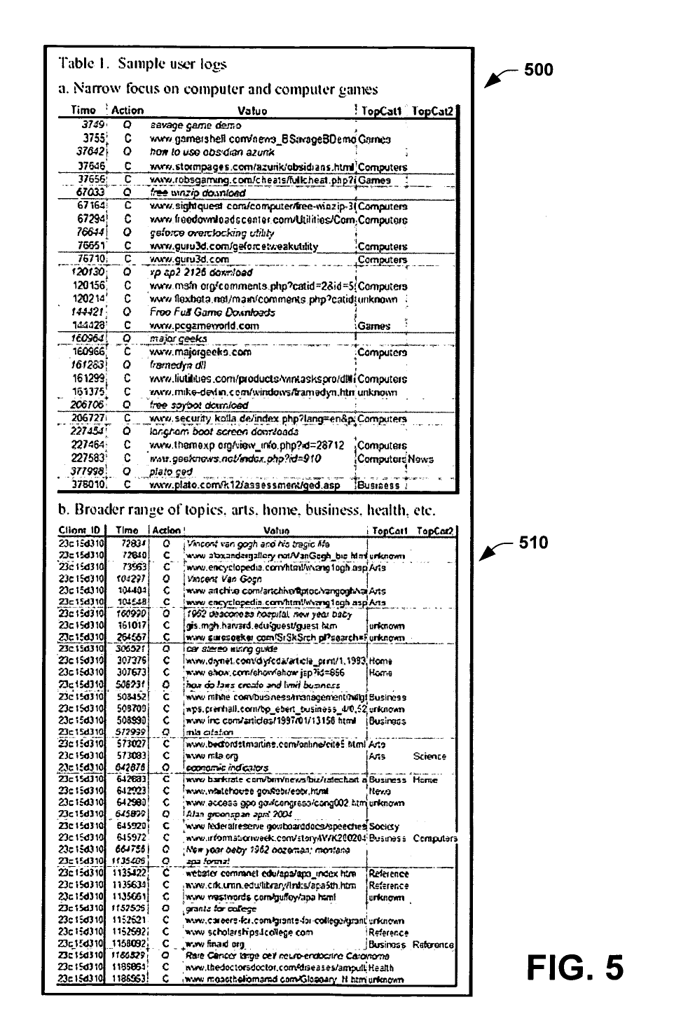

At 430, sample logs are considered, where a subset of these logs is depicted in FIG. 5. Tables 1a at 500 and 1b at 510 in FIG. 5 show samples from the logs of two individuals. For each action, the Elapsed Time is shown (in seconds when the data collection started), the Action (query (Q) or click through on a URL (C)), the Value of the action (the query string or the clicked URL), and the automatically assigned First-level Categories (labeled TopCatl and TopCat2). Both queries and URLs can be analyzed in developing topic models. The individual in Table 1a at 500 asks a number of different questions over a five week period, but most are in the general area of computers and computer games. The individual in Table 1b at 510 shows much more variability in topics, including queries about arts, business, reference and health, for example.

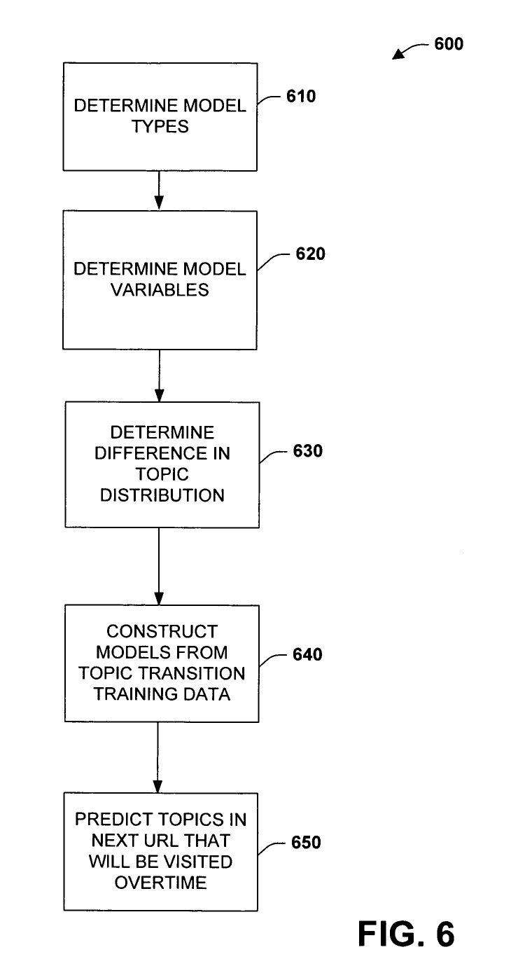

FIG. 6 illustrates an example model training process in accordance with an aspect of the subject invention. While, for purposes of simplicity of explanation, the methodologies are shown and described as a series or number of acts, it is to be understood and appreciated that the subject invention is not limited by the order of acts, as some acts may, in accordance with the subject invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention.

One focus of model experiments was to predict the topic of the next URL that an individual will visit over time. At 610, models were built using a subset of the data for training (e.g., data from week 1) and used to predict the remaining data (e.g., data from weeks 2-5). At 620, and as outlined above, the model variables explored were the type of model (Marginal, Markov, or Time-Specific Markov), and the cohort group used to estimate the topic probabilities (an Individual, a Group of similar individuals, or the entire Population). Also, the amount of training data was varied and used to build models and temporal characteristics of the training set.

At 630, several measures were determined for comparing the differences between topic distributions. In one aspect, Kullback-Leibler (KL) divergence was employed between two distributions. The KL divergence is a classic information-theoretic measure of the asymmetric difference between two distributions. Also, a Jensen-Shannon (JS) divergence was computed which is a symmetric variant of the KL divergence. The predictive accuracy of the models was measured in two different ways. The first approach computes a single score for each URL based on the overlap between the actual topic categories and the predicted topic categories. The second approach measures the accuracy of predicting each category, as is done in text classification experiments. The F1 measure was employed, which is the harmonic mean of precision and recall, where precision is the ratio of correct positives to predicted positives and recall is the ratio of correct positives to true positives. Results from all the measures are in general agreement.

At 640, models were constructed based on some training data and evaluate the models on a holdout set of testing data. At 650, for each test URL, the system predicted which of the topics it belongs to. Each URL can be associated with zero, one topic or more than one topic. These model predictions were compared with the true category assignments generated by the automatic procedure described below and report the micro-averaged F1 measure, which gives equal weight to the accuracy for each URL.

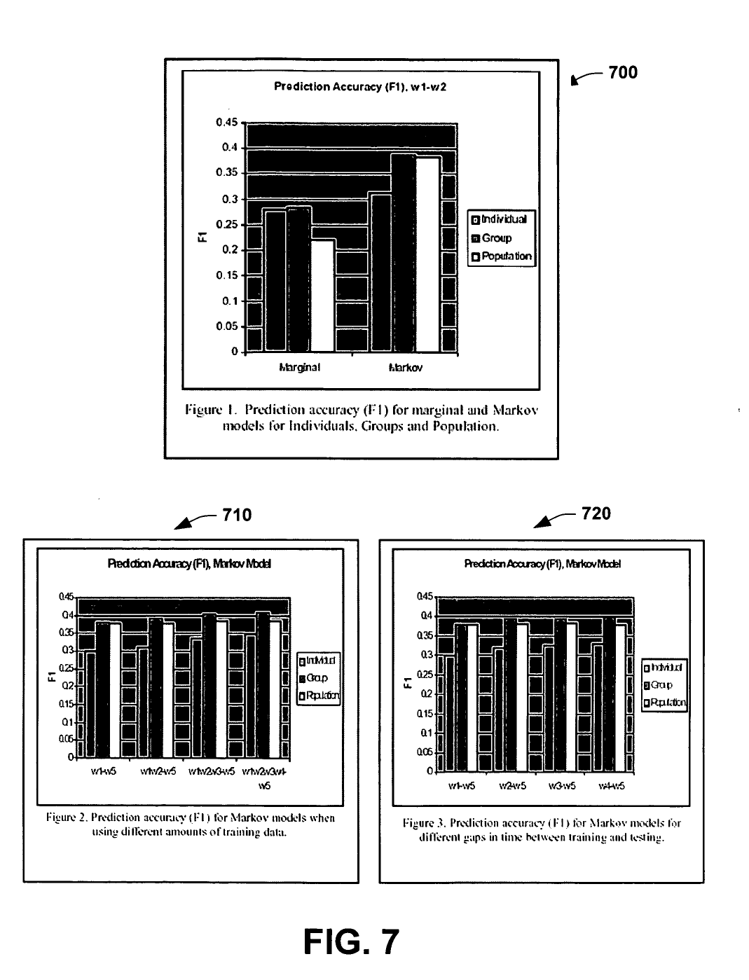

FIG. 7 is a diagram illustrating model characteristics in accordance with an aspect of the subject invention. FIG. 7 depicts graphs 700 through 720 for analyzing various models. At 700, Marginal and Markov Models are compared. The graph 700 shows the accuracy for topic predictions for the Marginal and Markov models, and for each group of users (Individual, Group and Population). For the data reported, week 1 (w1) data was used to train the models and evaluated the models on week 2 data (w2). For the Marginal model, topic predictions are most accurate when using the Individual and Group models. The similar performance of the Individual and Group models reflects the fact that users were grouped based on the maximum topic in week 1. The advantage of the Individual and Group models over the population models shows that users are consistent in the distribution of topics they visit from week 1to week 2.

Prediction accuracy is consistently higher with the Markov model than with the Marginal model for all groups. This shows that knowing the context of the previous topic helps predict the next topic. For the Markov model, topic predictions are most accurate with the Group and Population models. This may lead to the relatively poor performance of the Individual Markov model is a result of data sparcity, because many of the topic-topic transitions are not observed in the training period. If the self-prediction accuracy (using week 1 data to predict week 1 data) is observed, it is noted that the Individual model is the most accurate, with an F1 of 0.526. The over-fitting problem is clear when generalizing to week 2 data for individuals. The data sparcity issue can be accounted for when considering training size effects. Various techniques can be employed for smoothing the Individual model with the Group or Population models when there is insufficient data. Higher-order Markov models may be used to improve predictive accuracy.

The graph 710 shows the accuracy for topic predictions for Markov model for each group of users (Individual, Group and Population). The data reported here uses week 5 as the test data, and different amounts of training data from combinations of data from weeks 1-4. The predictive accuracy of all the models (Individual, Group and Population) increases as more training data is used. The increases are largest for the Individual and Group models. The Population model improves from 0.379 to 0.385 (1.5%), whereas the Group model improves from 0.381 to 0.409 (7.4%) and the Individual model improves from 0.301 to 0.347 (15.8%). The Group model shows small but consistent advantages.

The graph 720 shows the accuracy for topic predictions for Markov model for each group of users (Individual, Group and Population). The data reported here uses week 5 as the test data, and one week of training data with different time delays between training and testing. The predictive accuracy of all the models (Individual, Group and Population) increases as the period of time between the collection of data used for model construction and the data used for testing decreases. The Population model improves slightly from 0.379 to 0.381 (less than 1%) as the time gap decreases from 1 month (w1-w5) to 1 week (w4-w5). The Population models are relatively stable over the 5 week period that was examined. Individual and Group models show larger changes; the Group model improves from 0.381 to 0.398 (4.5%) and the Individual model improves from 0.301 to 0.332 (10.4%).

The Group model shows small but consistent advantages. Designers have also examined some finer-grained temporal dynamics. The construction of time-specific Markov models was explored, by developing different models for short term and long-term topic transitions. A short term transition was defined as one in which successive URL clicks happened within five minutes of each other; long-term transitions were those that happened with a gap of more than five minutes. Predictive accuracy for the short-term transitions is higher than for the long-term transitions, reflecting the fact that even individuals whose interactions cover a broad range of topics tend to focus on the same topic over the short term. When averaged over all transition times, there are only small changes in overall predictive accuracy. The time-specific Individual Markov models are somewhat more accurate than the general Individual Markov models (0.311 vs. 0.301). It is believed there is promise in understanding finer-grained temporal transitions, and models can be constructed that represent such differences.

When analyzing temporal effects, sampling issues need to be considered. In the analyses described above, the test period was fixed to week 5, and built different predictive models for weeks 1-4. Because not all individuals interacted with the system every week, there are somewhat different subsets of individuals represented in the different models. The temporal effects were also observed by building the models using week 1 data, and evaluating them using data from weeks 1-4. In this analysis, the training models are consistent, but the evaluation set changes. The pattern of results is similar to those shown in graph 720, although the overall differences are somewhat smaller. Individuals also could be chosen who were consistently active during the five week period, but this reduces the amount of data for estimating model parameters.

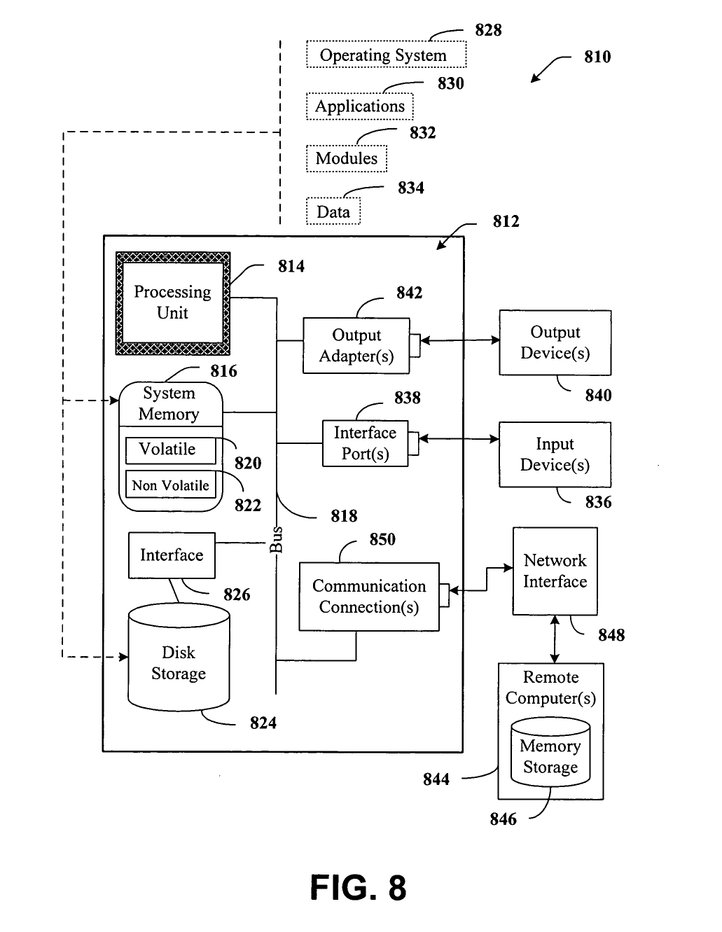

With reference to FIG. 8, an exemplary environment 810 for implementing various aspects of the invention includes a computer 812. The computer 812 includes a processing unit 814, a system memory 816, and a system bus 818. The system bus 818 couples system components including, but not limited to, the system memory 816 to the processing unit 814. The processing unit 814 can be any of various available processors. Dual microprocessors and other multiprocessor architectures also can be employed as the processing unit 814.

The system bus 818 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 816 includes volatile memory 820 and nonvolatile memory 822. The basic input/output system (BIOS), containing the basic routines to transfer information between elements within the computer 812, such as during start-up, is stored in nonvolatile memory 822. By way of illustration, and not limitation, nonvolatile memory 822 can include read only memory (ROM), programmable ROM (PROM), electrically programmable ROM (EPROM), electrically erasable ROM (EEPROM), or flash memory. Volatile memory 820 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 812 also includes removable/non-removable, volatile/non-volatile computer storage media. FIG. 8 illustrates, for example a disk storage 824. Disk storage 824 includes, but is not limited to, devices like a magnetic disk drive, floppy disk drive, tape drive, Jaz drive, Zip drive, LS-100 drive, flash memory card, or memory stick. In addition, disk storage 824 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 824 to the system bus 818, a removable or non-removable interface is typically used such as interface 826.

It is to be appreciated that FIG. 8 describes software that acts as an intermediary between users and the basic computer resources described in suitable operating environment 810. Such software includes an operating system 828. Operating system 828, which can be stored on disk storage 824, acts to control and allocate resources of the computer system 812. System applications 830 take advantage of the management of resources by operating system 828 through program modules 832 and program data 834 stored either in system memory 816 or on disk storage 824. It is to be appreciated that the subject invention can be implemented with various operating systems or combinations of operating systems.

A user enters commands or information into the computer 812 through input device(s) 836. Input devices 836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 814 through the system bus 818 via interface port(s) 838. Interface port(s) 838 include, for example, a serial port, a parallel port, a game port, and a universal serial bus (USB). Output device(s) 840 use some of the same type of ports as input device(s) 836. Thus, for example, a USB port may be used to provide input to computer 812, and to output information from computer 812 to an output device 840. Output adapter 842 is provided to illustrate that there are some output devices 840 like monitors, speakers, and printers, among other output devices 840, that require special adapters. The output adapters 842 include, by way of illustration and not limitation, video and sound cards that provide a means of connection between the output device 840 and the system bus 818. It should be noted that other devices and/or systems of devices provide both input and output capabilities such as remote computer(s) 844.

Computer 812 can operate in a networked environment using logical connections to one or more remote computers, such as remote computer(s) 844. The remote computer(s) 844 can be a personal computer, a server, a router, a network PC, a workstation, a microprocessor based appliance, a peer device or other common network node and the like, and typically includes many or all of the elements described relative to computer 812. For purposes of brevity, only a memory storage device 846 is illustrated with remote computer(s) 844. Remote computer(s) 844 is logically connected to computer 812 through a network interface 848 and then physically connected via communication connection 850. Network interface 848 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 850 refers to the hardware/software employed to connect the network interface 848 to the bus 818. While communication connection 850 is shown for illustrative clarity inside computer 812, it can also be external to computer 812. The hardware/software necessary for connection to the network interface 848 includes, for exemplary purposes only, internal and external technologies such as, modems including regular telephone grade modems, cable modems and DSL modems, ISDN adapters, and Ethernet cards.

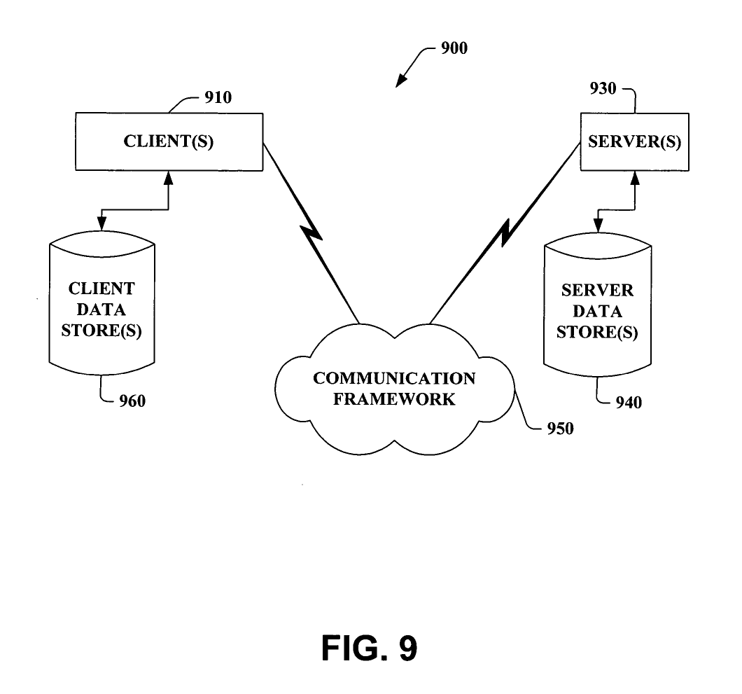

FIG. 9 is a schematic block diagram of a sample-computing environment 900 with which the subject invention can interact. The system 900 includes one or more client(s) 910. The client(s) 910 can be hardware and/or software (e.g., threads, processes, computing devices). The system 900 also includes one or more server(s) 930. The server(s) 930 can also be hardware and/or software (e.g., threads, processes, computing devices). The servers 930 can house threads to perform transformations by employing the subject invention, for example. One possible communication between a client 910 and a server 930 may be in the form of a data packet adapted to be transmitted between two or more computer processes. The system 900 includes a communication framework 950 that can be employed to facilitate communications between the client(s) 910 and the server(s) 930. The client(s) 910 are operably connected to one or more client data store(s) 960 that can be employed to store information local to the client(s) 910. Similarly, the server(s) 930 are operably connected to one or more server data store(s) 940 that can be employed to store information local to the servers 930.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A topic analysis system, comprising:
at least one learning model that is trained from information access data from a plurality of web sites; and
a search component that employs the learning model to predict potential future web sites or topics of interest.

2. The system of claim 1, the learning model is a Marginal model, a Markov model or a time-specific Markov model.

3. The system of claim 1, further comprising an evaluation data subset derived from a web access or search log.

4. The system of claim 3, the evaluation data subset includes basic data characteristics, topic categories, and sample log data.

5. The system of claim 1, the learning model is trained from topical categories associated with queries and/or universal resource locators (URLs) visited over time.

6. The system of claim 1, the learning model is trained from individuals, groups of individuals, and populations of users as a whole over time.

7. The system of claim 1, the learning model determines a probability that a user will transition from a given topic to another topic or to the same topic.

8. The system of claim 1, further comprising an analysis component to estimate model parameters and to apply smoothing to estimate model distributions.

9. The system of claim 1, the analysis component includes a maximum likelihood estimation process.

10. The system of claim 1, further comprising a component to collect training data, the training data including user queries, lists of search results returned, one or more URLs visited, a client identification, a time stamp, an action, and an action value.

11. The system of claim 10, further comprising a web directory component to facilitate collection of training data.

12. The system of claim 1, a divergence component for determining differences between topic distributions.

13. The system of claim 1, further comprising a scoring component to determine model accuracy based on an overlap between actual topic categories and predicted topic categories.

14. The system of 13, the scoring component includes a text classification predictor for automatically assigning topic tags.

15. A computer readable medium having computer readable instructions stored thereon for executing the components of claim 1.

16. A method for performing automated topic predictions, comprising:
automatically measuring a plurality of past user or group actions from a search log;
training at least one model from the past user or group actions; and
automatically predicting future topic selections based in part on the past user or group actions.

17. The method of claim 16, further comprising analyzing the past user or group actions in terms of topic transitions, topic dynamics, and temporal dynamics.

18. The method of claim 16, further comprising automatically analyzing universal resource locators visited by users or groups of users.

19. The method of claim 16, further comprising analyzing the model over varying degrees of time.

20. A system to facilitate automated topical searches, comprising:
means for collecting past user or group search data;
means for analyzing the past user or group search data; and
means for predicting future topics of interest from past user or group search data.
